(19) United States
(12) Patent Application Publication
(10) Pub. No.: US 2026/0130342 A1
(43) Pub. Date: May 14, 2026

(54) Choke-Less Animal Harness Device

(71) Applicant: Charles Gause, Columbus, OH (US)

(72) Inventor: Charles Gause, Columbus, OH (US)

(21) Appl. No.: 19/359,825

(22) Filed: Oct. 16, 2025

Related U.S. Application Data
(60) Provisional application No. 63/720,429, filed on Nov. 14, 2024.

(51) Int. Cl. A01K 27/00

(52) U.S. Cl. CPC A01K 27/002

(57) ABSTRACT

A choke-less animal harness device is provided. The device is comprised of a harness body configured for secure attachment around an animal without exerting pressure on sensitive anatomical regions like the neck or throat. The harness body comprises a forked chest area, configured in a V-shape to safely encircle the animal's chest without compressing airways or blood vessels, secured with individually adjustable leg loops, or underarm straps coupled to rear attachment straps in a second embodiment, ensuring optimal fit and minimal shifting.

### CROSS-REFERENCE TO RELATED APPLICATION

The present application claims priority to, and the benefit of, U.S. Provisional Application No. 63/720,429, which was filed on Nov. 14, 2024, and is incorporated herein by reference in its entirety.

### FIELD OF THE INVENTION

The present invention relates generally to the field of animal harnesses. More specifically, the present invention relates to an animal harness configured for secure attachment around an animal without exerting pressure on sensitive anatomical regions like the neck or throat. Accordingly, the present disclosure makes specific reference thereto. Nonetheless, it is to be appreciated that aspects of the present invention are also equally applicable to other like applications, devices, and methods of manufacture.

### BACKGROUND

Animal owners frequently use harnesses and collars to control, guide, or restrain their pets during various activities, including walking, training, or traveling. Traditional harnesses and collars often apply pressure directly to sensitive areas of the animal's neck, throat, trachea, and esophagus when tension is exerted. Such pressure can result in choking, discomfort, injury, or long-term health issues, negatively impacting animal welfare and owner satisfaction. Moreover, repetitive or sustained pressure around the neck can potentially restrict airflow and blood circulation, creating significant risks for respiratory distress and circulatory problems in animals. These adverse conditions pose a particular danger to smaller breeds or animals predisposed to respiratory sensitivity and can result in heightened anxiety or fear responses in pets, complicating handling and training efforts. Additionally, conventional harness designs often fail to distribute pulling forces evenly, concentrating stress on specific anatomical points and increasing the likelihood of irritation, abrasions, and muscular discomfort. Further, animals subjected to improperly fitting harnesses or collars frequently attempt to remove or resist the devices, leading to compromised control and safety risks for both animals and their handlers.

Therefore, there exists a long-felt need in the art for choke-less animal harness device that effectively prevents choking hazards by avoiding pressure on an animal's neck or throat region. There also exists a long-felt need in the art for choke-less animal harness device that securely and comfortably connects around the animal's legs and torso rather than relying on conventional neck-based attachment points. Moreover, there exists a long-felt need in the art for a choke-less animal harness device that is fully adjustable to accommodate varying sizes, breeds, and anatomical conformations of animals, ensuring optimal fit, comfort, and secure engagement.

The subject matter disclosed and claimed herein, in one embodiment thereof, comprises a choke-less animal harness device. The device is comprised of a harness body configured for secure attachment around an animal without exerting pressure on sensitive anatomical regions like the neck or throat. The harness body comprises a forked chest area, configured in a V-shape to safely encircle the animal's chest without compressing airways or blood vessels, secured with individually adjustable leg loops, or underarm straps coupled to rear attachment straps in a second embodiment, ensuring optimal fit and minimal shifting.

In this manner, the choke-less animal harness device of the present invention accomplishes all the forgoing objectives and provides an animal harness that completely avoids sensitive anatomical areas of an animal's neck and throat. To do so, the forked chest area wraps around the animal's front chest and is individually secured around each front leg, significantly improving harness stability and preventing choking hazards. Thus, the choke-less animal harness device provides a humane, secure, and effective alternative to traditional harnesses and collars, fulfilling the previously unmet need within the art for an animal harness solution designed specifically to protect animal health and comfort while ensuring optimal control and adjustability.

### SUMMARY

The following presents a simplified summary to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a choke-less animal harness device. The device comprises a body configured to securely and comfortably attach to animals such as pets, service animals, or working animals of varying sizes. The device avoids applying pressure to the animal's neck or throat, eliminating choking risks by distributing force around the midsection and legs.

The body is secured around the animal's midsection using a midsection strap with reciprocating fasteners such as side-release buckles, magnetic buckles, or adjustable locking clasps. An adjustment fastener allows precise customization for a secure and comfortable fit for various animal sizes and growth stages. A forked chest area that is generally V-shaped, eliminates choking hazards by wrapping separately around the animal's front chest without pressure on the neck or throat. The chest area includes two distinct sections positioned to avoid interference with the animal's airway and cervical structures.

In one embodiment, each chest section includes leg engagement loops that individually encircle the animal's front legs, stabilizing the harness against movement. Loops may be padded for comfort and include adjustable fasteners for custom fitting around each leg. In another embodiment, the device includes elongated underarm straps extending from each chest section under the animal's front legs toward the hindquarters, connecting to rear attachment straps along the animal's sides or back. Secure and adjustable fasteners join these straps, allowing precise adjustment to accommodate different animal shapes and sizes.

The invention also includes a method for using the first embodiment of the harness by placing each animal leg individually through corresponding loops in the forked chest area, securing the midsection strap around the torso, adjusting for customized fit, and attaching a leash for control and management.

Another method involves placing the second embodiment harness on the animal with elongated underarm straps passing beneath the front legs and connecting to rear attachment straps. Adjustment fasteners allow precise fitting, ensuring secure and comfortable positioning, after which a leash or restraint device may be attached for effective control of the animal.

Accordingly, the choke-less animal harness device of the present invention is particularly advantageous as it provides an animal harness that completely avoids sensitive anatomical areas of an animal's neck and throat. To do so, the forked chest area wraps around the animal's front chest and is individually secured around each front leg, significantly improving harness stability and preventing choking hazards. Thus, the choke-less animal harness device provides a humane, secure, and effective alternative to traditional harnesses and collars, fulfilling the previously unmet need within the art for an animal harness solution designed specifically to protect animal health and comfort while ensuring optimal control and adjustability. In this manner, the choke-less animal harness device overcomes the limitations of existing animal harnesses known in the art.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of a first potential embodiment of a choke-less animal harness device of the present invention while worn by an animal in accordance with the disclosed architecture;

FIG. 2 illustrates a perspective view of a second potential embodiment of a choke-less animal harness device of the present invention in accordance with the disclosed architecture;

FIG. 3 illustrates a perspective view of a second potential embodiment of a choke-less animal harness device of the present invention while worn by an animal in accordance with the disclosed architecture;

FIG. 4 illustrates a flowchart of a method of using one potential embodiment of a choke-less animal harness device of the present invention in accordance with the disclosed architecture; and

FIG. 5 illustrates a flowchart of a method of using one potential embodiment of a choke-less animal harness device of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth to provide a thorough understanding thereof. It may be evident, however, that the innovation can be practiced without these specific details. In other instances, well-known structures and devices are shown in block diagram form to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for a choke-less animal harness device that effectively prevents choking hazards by avoiding pressure on an animal's neck or throat region. There also exists a long-felt need in the art for a choke-less animal harness device that securely and comfortably connects around the animal's legs and torso rather than relying on conventional neck-based attachment points. Moreover, there exists a long-felt need in the art for a choke-less animal harness device that is fully adjustable to accommodate varying sizes, breeds, and anatomical conformations of animals, ensuring optimal fit, comfort, and secure engagement.

The present invention, in one exemplary embodiment, is comprised of a choke-less animal harness device. The device comprises a body configured to securely and comfortably attach to animals, including pets, service animals, or working animals of various sizes. The device avoids placing pressure on the animal's neck or throat, reducing choking risks by distributing force around the midsection and legs.

The body is secured around the animal's midsection with a midsection strap comprising reciprocating fasteners such as side-release buckles, magnetic buckles, or adjustable locking clasps. An adjustment fastener permits precise fitting for secure and comfortable accommodation of different animal sizes and growth stages. A forked chest area, generally V-shaped, eliminates choking risks by separately wrapping around the animal's chest without applying pressure on the neck or throat. The chest area includes two separate sections positioned to avoid interference with the animal's airway and cervical structures.

In one embodiment, each chest section comprises leg engagement loops configured to individually encircle the animal's front legs, stabilizing the harness against shifting. These loops may be padded for added comfort and include adjustable fasteners for precise fitting around each leg. In another embodiment, the device includes elongated underarm straps extending from each chest section beneath the animal's front legs toward the hindquarters, attaching to rear attachment straps positioned along the animal's sides or back. Secure and adjustable fasteners join these straps, enabling accurate adjustments for different animal shapes and sizes.

The invention further includes a method for using the first embodiment of the harness by individually placing the animal's legs through corresponding loops in the forked chest area, securing the midsection strap around the animal's torso, adjusting the fit as required, and attaching a leash for control and management. Another method of use includes placing the second embodiment harness on the animal, with elongated underarm straps passing beneath the front legs and connecting to rear attachment straps. Adjustment fasteners provide precise fitting, ensuring secure and comfortable positioning. A leash or restraint device may subsequently be attached for effective animal control.

As a result, the choke-less animal harness provides significant advantages by entirely avoiding sensitive anatomical areas of an animal's neck and throat. The forked chest area wraps around the animal's chest and individually secures around each front leg, enhancing harness stability and preventing choking. The choke-less animal harness thus offers a humane, secure, and effective alternative to traditional harnesses and collars, addressing the existing need for improved animal comfort, health protection, optimal control, and adjustability. Accordingly, the device overcomes the limitations found in conventional animal harnesses.

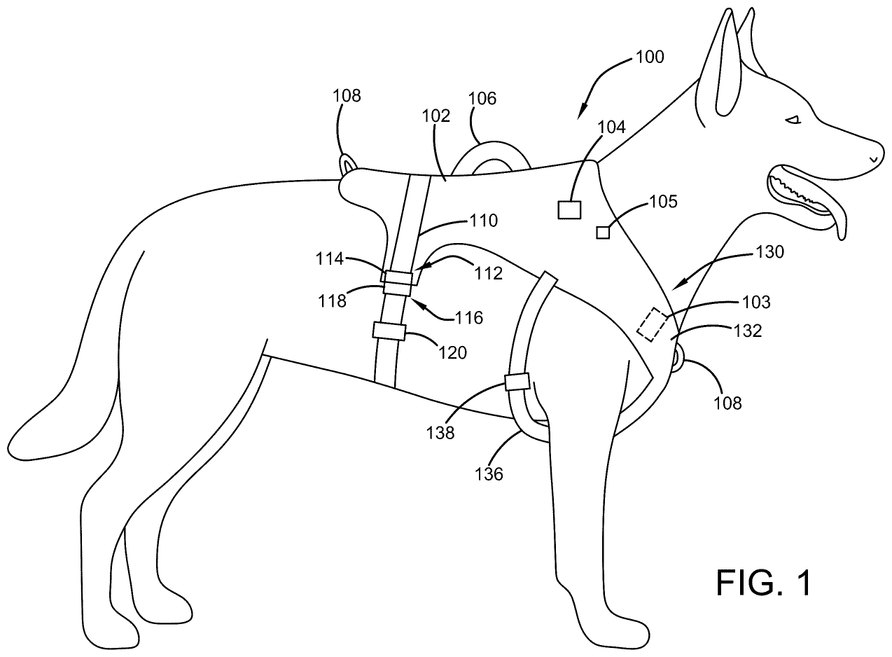

Referring initially to the drawings, FIG. 1 illustrates a perspective view of a first potential embodiment of a choke-less animal harness device 100 of the present invention while worn by an animal in accordance with the disclosed architecture. The device 100 is comprised of a body 102 designed to securely and comfortably attach to an animal, including, but not limited to, domesticated pets such as dogs and cats, as well as service animals, therapy animals, or working animals of varying size and breed. Unlike traditional harnesses or collars, the device 100 eliminates the risk of choking by avoiding pressure on the animal's neck and throat. Instead, the harness is designed to distribute force around the midsection and legs, ensuring a safe, comfortable, and non-restrictive fit.

The body 102 may be made from materials including, but not limited to, nylon webbing, polyester, polypropylene webbing, leather, neoprene, reinforced fabrics, synthetic composites, or combinations thereof. In certain embodiments, selected materials may provide specific beneficial attributes such as enhanced strength, tear resistance, elasticity, moisture-wicking, antimicrobial protection, breathability, or thermal regulation. The body 102 may additionally include padding 103 made from materials such as closed-cell foam, memory foam, EVA foam, gel inserts, fleece, or mesh to maximize comfort and reduce friction or irritation to the animal's skin and coat during prolonged wear.

The body 102 may also incorporate reflective elements 104 strategically positioned to enhance visibility, particularly during nighttime or low-light conditions. Reflective elements 104 may include reflective stitching, reflective woven strips, heat-transferred reflective labels, reflective patches, or reflective coatings applied through printing, laminating, heat bonding, stitching, or ultrasonic welding. The body 102 may also be comprised of a fastener 105, such as but not limited to a hook surface, a loop surface, etc. that allows for the addition of patches or other identifiers to the body 102.

The body 102 is further comprised of at least one handle 106. In one embodiment, the handle 106 is comprised of a textured, non-slip handle made from a non-slip material such as but not limited to rubber. In one embodiment, the handle 106 is a contoured handle.

At least one leash attachment point 108 is positioned on or integrated with the body 102, allowing secure connection of a leash, tether, or other restraint mechanisms. The leash attachment point 108 may include but is not limited to D-rings, O-rings, triangular rings, rectangular loops, swivel attachments, snap-hooks, carabiners, reinforced fabric loops, or metal eyelets. The leash attachment points 108 may be rigidly fixed, pivotable, rotatable, removable, or adjustable in position along the body 102 to accommodate varied leash attachment configurations or animal behaviors. Multiple leash attachment points 108 may be located at different regions on the body 102, such as front-chest regions, mid-back locations, or rearward locations, providing multiple restraint points and versatility based upon the animal's temperament, size, training needs, or owner preference.

The body 102 is secured around the animal's midsection by a midsection strap 110. The midsection strap 110 includes a first end 112 comprising a first fastener 114 and a second end 116 comprising a second fastener 118. The fasteners 114, 118 preferably comprise reciprocating fasteners such as male and female side-release buckles, snap-fit buckles, magnetic coupling buckles, hook-and-loop fasteners, quick-release cam buckles, or adjustable locking clasps. The length and tension of the midsection strap 110 may be adjusted via at least one adjustment fastener 120. Adjustment fasteners 120 may comprise sliding tri-glide buckles, cam-lock adjusters, ladder-lock buckles, friction-fit buckles, ratchet-style adjusters, or other similar devices. The adjustment fastener 120 permits precise customization of the midsection strap 110 length, ensuring a comfortable and secure fit that accommodates animals of varying body size, conformation, or growth stages.

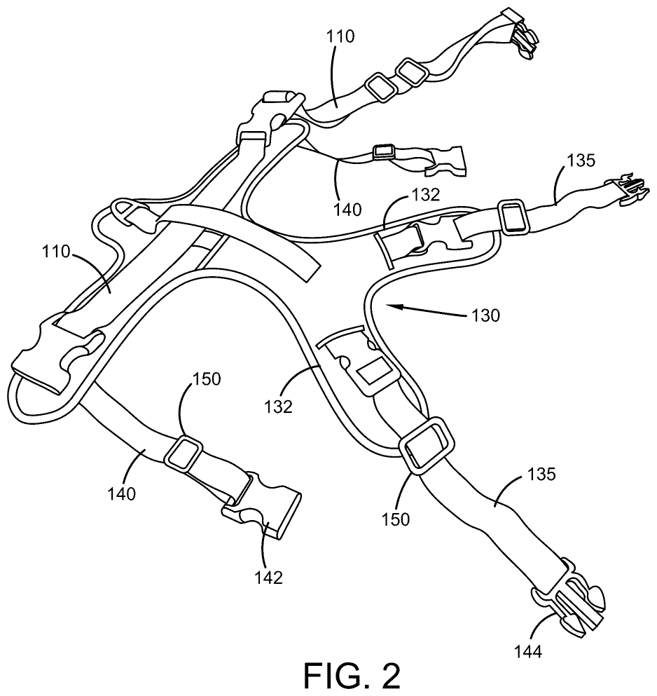

The body 102 is further comprised of a forked chest area 130 that is generally configured in a V-shape (as best seen in FIG. 2) to eliminate potential choking hazards commonly encountered in conventional collars and harnesses. More specifically, the forked chest area 130 includes two separate and distinct sections 132 positioned such that each section 132 wraps around the animal's front chest without directly connecting or placing pressure across the animal's neck or throat. Each section 132 thereby maintains separation, preventing interference with the animal's airway, trachea, esophagus, or cervical blood vessels.

In one embodiment, each chest section 132 comprises at least one leg engagement loop 136 configured to securely encircle each of the animal's front legs individually, as seen in FIG. 1. The loops 136 stabilize each chest section 132 against shifting or rotating during animal movement. In one embodiment, the loop 136 is a padded loop to increase animal comfort and reduce irritation during prolonged or vigorous use. Furthermore, the loop 136 may include an adjustment fastener 138, comprising sliding tri-glide adjusters, ladder-lock buckles, friction-fit buckles, or hook-and-loop fasteners, allowing the user to adjust each loop's 136 diameter for precise fitment around each leg of the animal.

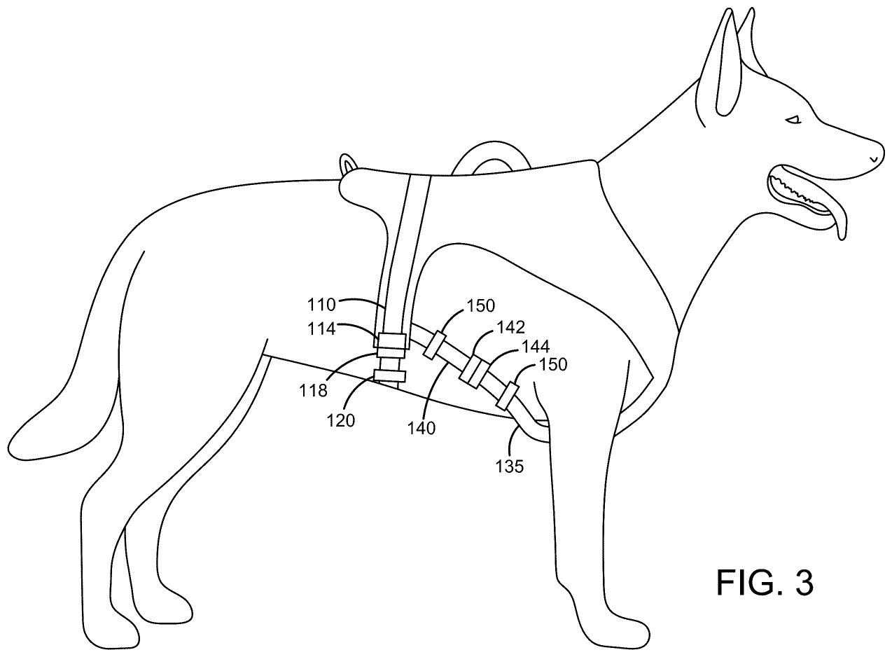

In an alternative embodiment as seen in FIG. 3, the body 102 comprises at least two rear attachment straps 140 extending rearwardly along the sides or back of the animal. Each chest section 132 further comprises at least one elongated underarm strap 135 routed from the chest area, beneath each respective front leg (armpit), and extending rearwardly toward the animal's hindquarters, where each strap 135 attaches to the corresponding rear attachment strap 140. Each rear attachment strap 140 comprises a first fastener 142, which couples to a corresponding second fastener 144 provided on the elongated underarm strap 135. Fasteners 142, 144 may comprise side-release buckles, snap-fit couplers, hook-and-loop fasteners, magnetic connectors, or similar fastening mechanisms providing secure and easily releasable engagement. Both elongated underarm straps 135 and rear attachment straps 140 comprise at least one adjustment fastener 150, including sliding tri-glide buckles, cam-lock adjusters, ladder-lock buckles, ratchet mechanisms, or friction-fit adjusters, permitting selective adjustment of length and tension to optimize comfort and secure attachment around the animal's body. Such adjustability accommodates animals of various breeds, sizes, shapes, and coat thicknesses.

As a result, the choke-less animal harness device 100 provides a safer, more comfortable, and humane solution by uniquely avoiding pressure on sensitive anatomical regions such as the animal's neck and throat.

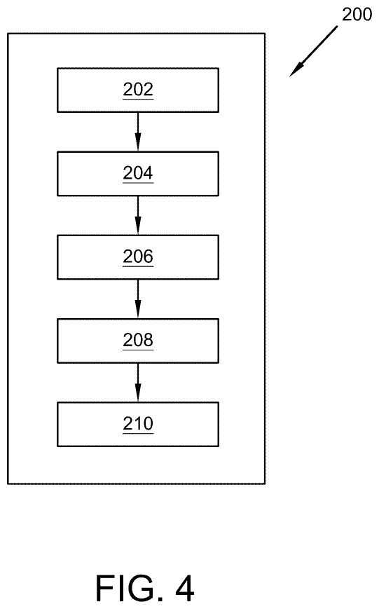

The present invention is also comprised of a method of use 200 of the first embodiment of the choke-less animal harness device 100, as illustrated in FIG. 4. First, the device 100 comprising a body 102 having a forked chest area 130, a midsection strap 110, at least one handle 106, and at least one leash attachment point 108 is provided [Step 202]. Next, the body 102 is positioned onto an animal by placing each front leg of the animal individually through a corresponding leg engagement loop 136 located on each chest section 132, wherein the forked chest area 130 wraps around the animal's front chest region without applying pressure to the animal's neck or throat area [Step 204]. Then, the midsection strap 110 is positioned around the animal's mid-torso region, after which the first fastener 114 located on the first end 112 of the midsection strap 110 is connected to the corresponding second fastener 118 located on the second end 116 of the midsection strap 110, securely closing and fastening the device 100 around the animal's midsection [Step 206]. Subsequently, the adjustment fastener 120 provided on the midsection strap 110 and adjustment fasteners 138 provided on each leg engagement loop 136 are selectively adjusted to achieve an optimal, customized fit accommodating the particular size, breed, and conformation of the animal, ensuring comfort and secure restraint [Step 208]. Finally, a leash, tether, or similar restraint device is selectively attached to at least one leash attachment point 108 on the body 102 for controlled guidance, training, or management of the animal [Step 210].

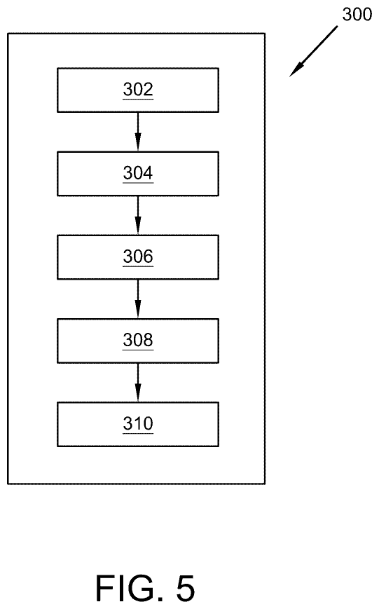

The present invention is further comprised of a method of use 300 of the second embodiment of the choke-less animal harness device 100, as illustrated in FIG. 5. First, the device 100 comprising a body 102 having a forked chest area 130, elongated underarm straps 135, rear attachment straps 140, at least one handle 106, and at least one leash attachment point 108 is provided [Step 302]. Next, the body 102 is placed onto an animal such that each separate chest section 132 of the forked chest area 130 comfortably engages the animal's chest without applying direct pressure onto the animal's neck, throat, or cervical structures, and wherein each elongated underarm strap 135 extends beneath each respective front leg (armpit region) and rearwardly toward the animal's hindquarters [Step 304]. Then, each elongated underarm strap 135 is connected to a corresponding rear attachment strap 140 positioned along the sides and/or back of the animal by engaging the first fastener 142 provided on each rear attachment strap 140 with the corresponding second fastener 144 provided on each elongated underarm strap 135, thereby securing the body 102 around the animal's body [Step 306]. Subsequently, the adjustment fasteners 150 located on both the elongated underarm straps 135 and rear attachment straps 140 can be adjusted, achieving a precise and comfortable fit accommodating variations in the animal's size, breed, growth stage, and coat thickness, as well as ensuring the secure positioning and minimal shifting of the device 100 during movement [Step 308]. Finally, a leash, tether, or other restraint mechanism may be attached to at least one leash attachment point 108 integrated onto the body 102 for effective control, management, training, or guidance of the animal during activities or operations [Step 310].

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “choke-less animal harness device” and “device” are interchangeable and refer to the choke-less animal harness device 100 of the present invention.

Notwithstanding the forgoing, the choke-less animal harness device 100 of the present invention and its various components can be of any suitable size and configuration as is known in the art without affecting the overall concept of the invention, provided that they accomplish the above-stated objectives. One of ordinary skill in the art will appreciate that the size, configuration, and material of the choke-less animal harness device 100 as shown in the FIGS. are for illustrative purposes only, and that many other sizes and shapes of the choke-less animal harness device 100 are well within the scope of the present disclosure. Although the dimensions of the choke-less animal harness device 100 are important design parameters for user convenience, the choke-less animal harness device 100 may be of any size, shape, and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A choke-less animal harness device comprising:
a body comprising:
a forked chest area comprising a first chest section comprised of a first leg engagement loop and a second chest section chest comprised of a second leg engagement loop, wherein the first chest section and the second chest section are positioned to wrap around a front chest region of the animal without applying pressure to a neck or throat area of the animal;
a midsection strap configured to secure the body around a midsection of the animal, the midsection strap comprising a first end having a first fastener and a second end having a second fastener configured to engage the first fastener to securely fasten the body around the animal;
a leash attachment point; and
a handle coupled to the body.

2. The choke-less animal harness device of claim 1, wherein the first engagement loop is comprised of a first adjustment fastener comprised of a sliding tri-glide adjuster, a ladder-lock buckle, a friction-fit buckle, or a hook-and-loop fastener.

3. The choke-less animal harness device of claim 1, wherein the midsection strap is comprised of a second adjustment fastener comprised of a sliding tri-glide adjuster, a ladder-lock buckle, a friction-fit buckle, or a hook-and-loop fastener.

4. The choke-less animal harness device of claim 1, wherein the body is comprised of a reflective element.

5. The choke-less animal harness device of claim 4, wherein the reflective element is comprised of a reflective stitching, a reflective woven strip, a heat-transferred reflective label, a reflective patch, or a reflective coating.

6. The choke-less animal harness device of claim 1, wherein the body is comprised of a padding.

7. The choke-less animal harness device of claim 1, wherein the leash attachment point is comprised of a D-ring, an O-ring, a triangular ring, a rectangular loop, a swivel attachment, a snap-hook, a carabiner, a fabric loop, or a metal eyelet.

8. The choke-less animal harness device of claim 1, wherein the body is comprised of a hook surface.

9. The choke-less animal harness device of claim 1, wherein the body is comprised of a loop surface.

10. A choke-less animal harness device comprising:
a body comprising:
a forked chest area comprising a first chest section comprised of a first underarm strap comprised of a first fastener and a second chest section chest comprised of a second underarm strap comprised of a second fastener, wherein the first chest section and the second chest section are positioned to wrap around a front chest region of the animal without applying pressure to a neck or throat area of the animal;
a midsection strap configured to secure the body around a midsection of the animal, the midsection strap comprising a first end having a third fastener and a second end having a fourth fastener configured to engage the third fastener to securely fasten the body around the animal;
a first rear attachment strap comprised of a fifth fastener and a second rear attachment strap comprised of a sixth fastener;
a leash attachment point; and
a handle coupled to the body.

11. The choke-less animal harness device of claim 10, wherein the first underarm strap is comprised of a first adjustment fastener comprised of a sliding tri-glide adjuster, a ladder-lock buckle, a friction-fit buckle, or a hook-and-loop fastener.

12. The choke-less animal harness device of claim 11, wherein the midsection strap is comprised of a second adjustment fastener comprised of a sliding tri-glide adjuster, a ladder-lock buckle, a friction-fit buckle, or a hook-and-loop fastener.

13. The choke-less animal harness device of claim 12, wherein the first rear attachment strap is comprised of a third adjustment fastener comprised of a sliding tri-glide adjuster, a ladder-lock buckle, a friction-fit buckle, or a hook-and-loop fastener.

14. The choke-less animal harness device of claim 13, wherein the leash attachment point is comprised of a D-ring, an O-ring, a triangular ring, a rectangular loop, a swivel attachment, a snap-hook, a carabiner, a fabric loop, or a metal eyelet.

15. The choke-less animal harness device of claim 14, wherein the body is comprised of a reflective element.

16. The choke-less animal harness device of claim 15, wherein the reflective element is comprised of a reflective stitching, a reflective woven strip, a heat-transferred reflective label, a reflective patch, or a reflective coating.

17. The choke-less animal harness device of claim 10, wherein the body is comprised of a hook surface.

18. The choke-less animal harness device of claim 10, wherein the body is comprised of a loop surface.

19. A method of using a choke-less animal harness device, the method comprising the following steps:
providing a choke-less animal harness device comprised of a body having a forked chest area with a first chest section comprised of a first leg engagement loop and a second chest section comprised of a second leg engagement loop, a midsection strap, a handle, and a leash attachment point;
positioning the body onto an animal by individually placing a first front leg of the animal through the first leg engagement loop and a second front leg of the animal through the second leg engagement loop, such that the forked chest area wraps around a front chest region of the animal without applying pressure to a neck or a throat area of the animal;
positioning the midsection strap around a mid-torso region of the animal;
connecting a first fastener located on a first end of the midsection strap to a corresponding second fastener located on a second end of the midsection strap to securely fasten the body around the midsection of the animal;
adjusting a first length of the midsection strap, a second length of the first leg engagement loop, and a third length of the second leg engagement loop; and
attaching a leash or a restraint mechanism to the leash attachment point.

20. The method of using a choke-less animal harness device of claim 19, wherein the body is further comprised of a reflective element.
